(19) United States
(12) Patent Application Publication
(10) Pub. No.: US 2026/0368127 A1
(43) Pub. Date: Nov. 19, 2026

(54) METHOD FOR EXECUTING INTER-CHIP COMMUNICATION TASK, AND RELATED PRODUCT

(71) Applicant: Shanghai Cambricon Information Technology Co., Ltd, Shanghai (CN)

(72) Inventor: Lu CHAO, Shanghai (CN)

(21) Appl. No.: 19/137,163

(22) PCT Filed: Aug. 11, 2023
(86) PCT No.: PCT/CN2023/112579

§ 371 Date: Jun. 9, 2025

(30) Foreign Application Priority Data
Dec. 9, 2022 (CN) 202211589123.4

(51) Int. Cl. G06F 15/173

(52) U.S. Cl. CPC G06F 15/17306

(57) ABSTRACT

The present disclosure provides a method for performing inter-chip communication tasks and related products, where the method may be included in a combined processing apparatus, and the combined processing device may also include a universal interconnect interface and other processing apparatuses. The computing apparatus interacts with other processing apparatuses to jointly complete computing operations specified by the user. The combined processing apparatus may also include a storage apparatus, which is connected to a device and other processing apparatuses respectively, for storing data of the device and other processing apparatuses.

### CROSS REFERENCE TO RELATED APPLICATION

The present application is a 371 of international Application PCT/CN2023/112579, filed Aug. 11, 2023, which claims priority to a Chinese Patent Application No. 202211589123.4 with the title of “Method for executing inter-chip communication task, and related product” filed on Dec. 9, 2022. The contents of the applications are incorporated herein by reference in their entireties.

### TECHNICAL FIELD

The present disclosure relates to the field of chips, and more specifically, to the field of inter-chip communication of chips.

### BACKGROUND

How to program software based on efficient inter-chip communication devices unique to chips is a key issue in achieving highly scalable artificial intelligence network training. There are two core problems in inter-chip communication: one is how to write data to the remote chip, and the other is how to sense whether the data awaited has arrived at the remote chip. Among them, the communication synchronization of the latter is the main focus of the present disclosure. However, the use of computing cores for polling will lead to extremely scarce computing resources and eventually result in communication deadlock. How to avoid communication deadlock and improve the utilization of computing resources in the case of a single computing core is a problem that is expected to be solved.

### SUMMARY

One purpose of the present disclosure is to solve how to utilizee a single computing core of an artificial intelligence chip to avoid communication deadlock through coroutine programming. A further purpose of the present disclosure is to explore how to utilize a single computing core of an artificial intelligence chip to complete time-division multiplexing inter-chip communication through coroutine programming to support concurrent communication tasks.

According to a first aspect of the present disclosure, a method for executing an inter-chip communication task is provided, where the inter-chip communication task is described by a communication primitive queue, the communication primitive queue includes a plurality of communication primitives, and the plurality of communication primitives include serial communication primitives connected in series. The method includes: executing a search for the communication primitive queue to determine states of the serial communication primitives in the communication primitive queue; in response to searching for an interrupted serial communication primitive, re-executing the communication primitive queue starting from the interrupted serial communication primitive.

According to a second aspect of the present disclosure, an electronic device is provided. The electronic device includes one or more processors and a memory, where the memory stores computer executable instructions, and when the computer executable instructions are executed by the one or more processors, the electronic device executes the method described above.

According to a third aspect of the present disclosure, a computer-readable storage medium is provided. The computer-readable storage medium includes computer executable instructions, and when the computer executable instructions are executed by one or more processors, the method described above is executed.

The technical solution provided by the present disclosure may bring at least one of the following beneficial effects: without introducing a hardware multi-threading mechanism, the time-division multiplexing capability of the computing core is realized by using a software coroutine method, so that the computing core may be fully utilized and task deadlock may be avoided. The coroutine execution process has relatively small changes to the hardware, and generally supports various single instruction multiple data (SIMD) processing architectures to realize software time-division multiplexing. In addition, through the asynchronous confirmation method of which the primitive jump mechanism supports asynchronous communication primitives, the automatic software communication retransmission may be realized without modifying the OP (communication primitive) logic. Through the alternating execution mechanism, the concurrent execution of the plurality of communication primitives may be supported, which is similar to the effect of single-core multi-threading and saves the use of computing cores. The solution of the present disclosure is sufficient to solve the deadlock problem caused by a communication blockage.

### DRAWINGS

By reading the following detailed description with reference to the accompanying drawings, the above-mentioned and other objects, features and technical effects of the exemplary embodiments of the present disclosure will become easier to understand. In the accompanying drawings, several embodiments of the present disclosure are shown in an exemplary but not restrictive manner, and the same or corresponding reference numerals indicate the same or corresponding parts.

FIG. 1 illustrates a schematic diagram of a structure of a board card 10 according to an embodiment of the present disclosure.

FIG. 2 illustrates a schematic diagram of a combined processing apparatus 101 of this embodiment.

FIG. 3 illustrates a schematic diagram of the internal structure of the computing apparatus 201.

FIG. 4 illustrates an internal architecture of the processing core.

FIG. 5 illustrates a method for executing inter-chip communication tasks according to an embodiment of the present disclosure.

FIG. 6 illustrates an example of coroutine execution according to an embodiment of the present disclosure.

FIG. 7 illustrates possible changes in the work state of a communication primitive (OP).

FIG. 8 illustrates a schematic diagram of execution situation of a serial primitive queue according to an embodiment of the present disclosure.

FIG. 9 illustrates a schematic diagram of a communication primitive involving in-place operations.

FIG. 10 illustrates an exemplary application scenario in which there are a plurality of concurrent communication primitives.

FIG. 11a to FIG. 11f illustrate schematic diagrams of setting concurrent communication primitives among serial communication primitives according to an embodiment of the present disclosure.

### DETAILED DESCRIPTION

Technical solutions in embodiments of the present disclosure will be described clearly and completely hereinafter with reference to the drawings in the embodiments of the present disclosure. Obviously, the embodiments to be described are merely some rather than all examples of the present disclosure. All other embodiments obtained by those skilled in the art based on the embodiments of the present disclosure without creative efforts shall fall within the protection scope of the present disclosure.

It should be understood that terms such as “first”, “second”, “third”, and “fourth” appear in the claims, the specification, and drawings are used for distinguishing different objects rather than describing a specific order. “First”, “second”, “third”, “fourth” and the like do not only mean one, but also may mean multiple. The terms “including” and “comprising” used in the specification and the claims of the present disclosure indicate the presence of a feature, an entity, a step, an operation, an element, and/or a component, but do not exclude the existence or addition of one or more other features, entities, steps, operations, elements, components, and/or collections thereof.

It should also be understood that the terms used in the specification of the present disclosure are merely intended to describe specific embodiments rather than to limit the present disclosure. As being used in the specification and the claims of the disclosure, unless the context clearly indicates otherwise, the singular forms “a”, “an”, and “the” are intended to include the plural forms. It should also be understood that the term “and/or” used in the specification and the claims of the present disclosure refers to any and all possible combinations of one or more of relevant listed items and includes these combinations.

As being used in this specification and the claims, the term “if” can be interpreted as “when”, or “once” or “in response to a determination” or “in response to a detection” depending on the context. Similarly, the phrases “if it is determined” or “if [described condition or event] is detected” may be interpreted to mean “upon determination” or “in response to determination” or “upon detection of [described condition or event]” or “in response to detection of [described condition or event],” depending on the context.

Detailed embodiments of the present disclosure are described below in detail with reference to the accompanying drawings.

The current semiconductor manufacturing process starts with a complete wafer. The wafer is a circular thin sheet made of pure silicon. It is generally divided into 6-inch, 8-inch, 12-inch and other specifications. The wafer will be cut into small pieces, which are called dies. Each die will be mounted with a chip and the wiring is arranged to achieve specific electrical functions. Then the die is packaged into a particle in unit of die. The purpose of packaging is to place, fix, seal, protect the chip and enhance the electrical and thermal performance. At the same time, the contacts of the chip are connected to the pins of the package shell with wires, and a chip packaging structure is completed.

The memory is used to temporarily store the computing data required by the system on chip and the data exchanged with the external memory. In this embodiment, the memory may be a high bandwidth memory (HBM), which is a high-performance dynamic random access memory (DRAM) made based on a 3D stacking process. It is suitable for applications with high memory bandwidth requirements, such as graphics processors, online switching and forwarding equipments (such as routers, switches), and so on.

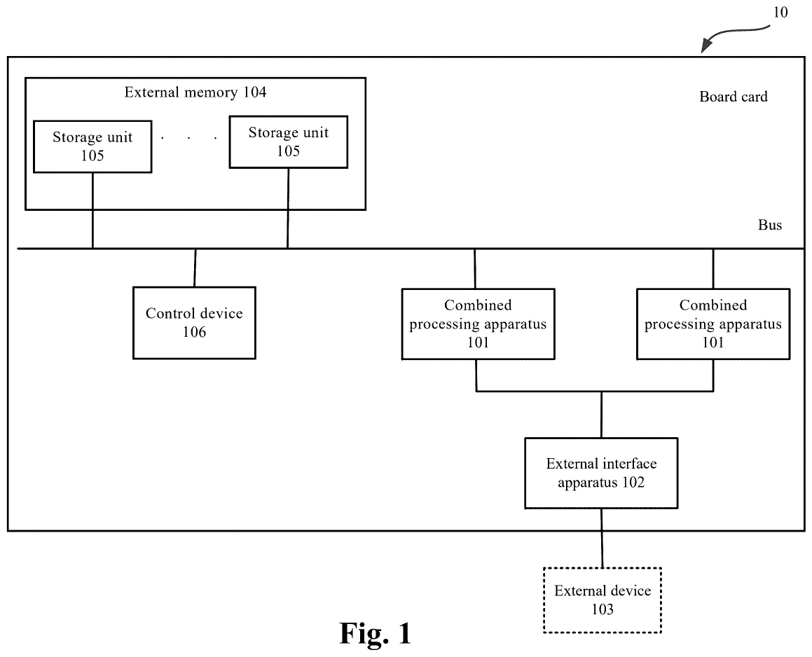

System on chip (SoC) refers to a technology that integrates a complete system on a single chip, packaging all or part of the necessary electronic circuits. In this embodiment, the system on chip is assembled on a board card. FIG. 1 illustrates a schematic diagram of a structure of a board card 10 according to an embodiment of the present disclosure. As shown in FIG. 1, the board 10 includes a combined processing apparatus 101, which is an artificial intelligence computing unit used to support various deep learning and machine learning algorithms to meet the intelligent processing requirements in complex scenarios in the fields of computer vision, speech, natural language processing, data mining, and so on. Especially, deep learning technologies are widely applied in the field of cloud intelligence. A prominent feature of a cloud intelligence application is that the amount of input data is large, which has a high requirement on a storage capability and a computing capability of a platform. A board card 10 in this embodiment is applicable to a cloud intelligence application, and has a huge off-chip storage, an on-chip storage, and a powerful computing capability.

The combined processing apparatus 101 is connected to an external device 103 via an external interface apparatus 102. The external device 103 is, for example, a server, a computer, a camera, a display, a mouse, a keyboard, a network card, or a Wifi interface and so on. The data to be processed can be transmitted from the external device 103 to the combined processing apparatus 101 via the external interface apparatus 102. The computation results of the combined processing apparatus 101 may be transmitted back to the external device 103 via the external interface apparatus 102. According to different application scenarios, the external interface apparatus 102 may have different interface forms, for example, a peripheral component interconnect express (PCIe) interface and so on.

The board card 10 also includes an external memory 104 for storing data, which includes one or more storage units 105. The external memory 104 is connected to the control device 106 and the combined processing apparatus 101 through a bus for data transmission. The control device 106 in board card 10 is configured to regulate and control the state of the combined processing apparatus 101. To this end, in an application scenario, the control device 106 may include a singlechip, also known as a micro controller unit (MCU).

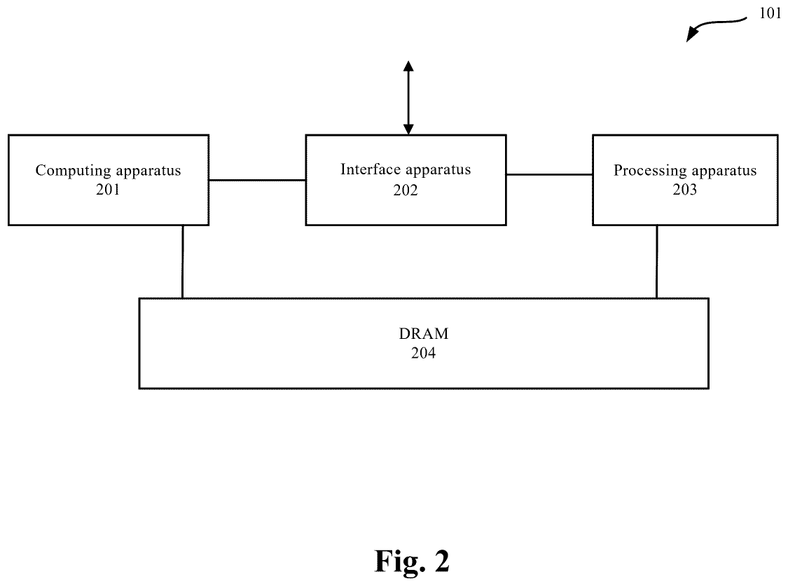

FIG. 2 illustrates a schematic diagram of a combined processing apparatus 101 of this embodiment. As shown in FIG. 2, the combined processing apparatus 101 includes a computing apparatus 201, an interface apparatus 202, a processing apparatus 203, and DRAM 204. In one application scenario, the computing apparatus 201, the interface apparatus 202, and the processing apparatus 203 are integrated into the aforementioned system on chip. In another application scenario, the computing apparatus 201 itself is the aforementioned system on chip.

The computing apparatus 201 is configured to execute an operation specified by a user, and is mainly implemented as a single-core intelligent processor or a multi-core intelligent processor. The computing apparatus 201 is configured to execute depth learning or computation of machine learning. The computing apparatus 201 may interact with the processing apparatus 203 through the interface apparatus 202 to jointly complete the operation specified by the user.

The computing apparatus 201 is configured to transfer data and control instructions between the computing apparatus 201 and the processing apparatus 203. For example, the computing apparatus 201 may obtain input data from the processing apparatus 203 via the interface apparatus 202 and write the data into a storage apparatus on the chip of the computing apparatus 201. Further, the computing apparatus 201 may obtain control instructions from the processing apparatus 203 via the interface apparatus 202 and write the control instructions into a control cache on the chip of the computing apparatus 201. Alternatively or optionally, the interface apparatus 202 may also read data in the storage apparatus of the computing apparatus 201 and transmit the data to the processing apparatus 203.

As a general-purpose processing device, the processing apparatus 203 executes basic control including, but not limited to, data transfer, and turning on and/or stopping of the computing apparatus 201. According to different implementations, the processing apparatus 203 may be a central processing unit or a graphics processing unit or one or more types of processors in other general-purpose and/or special-purpose processors. These processors include, but not limited to, a digital signal processor (DSP), an application specific integrated circuit (ASIC), a field-programmable gate array (FPGA) or another programmable logic device, a discrete gate or transistor logic device, a discrete hardware component, or the like and their number may be determined according to actual needs. As mentioned above, only with respect to the computing apparatus 201 of the present disclosure, it may be viewed as having a single-core structure or a homogeneous multi-core structure. However, when the computing apparatus 201 and the processing apparatus 203 are considered together, they are considered to form a heterogeneous multi-core structure.

DRAM 204 is the aforementioned high-bandwidth memory, which is used to store data to be processed. The size is usually 16 G or larger, and is used to save data of the computing apparatus 201 and/or the processing apparatus 203.

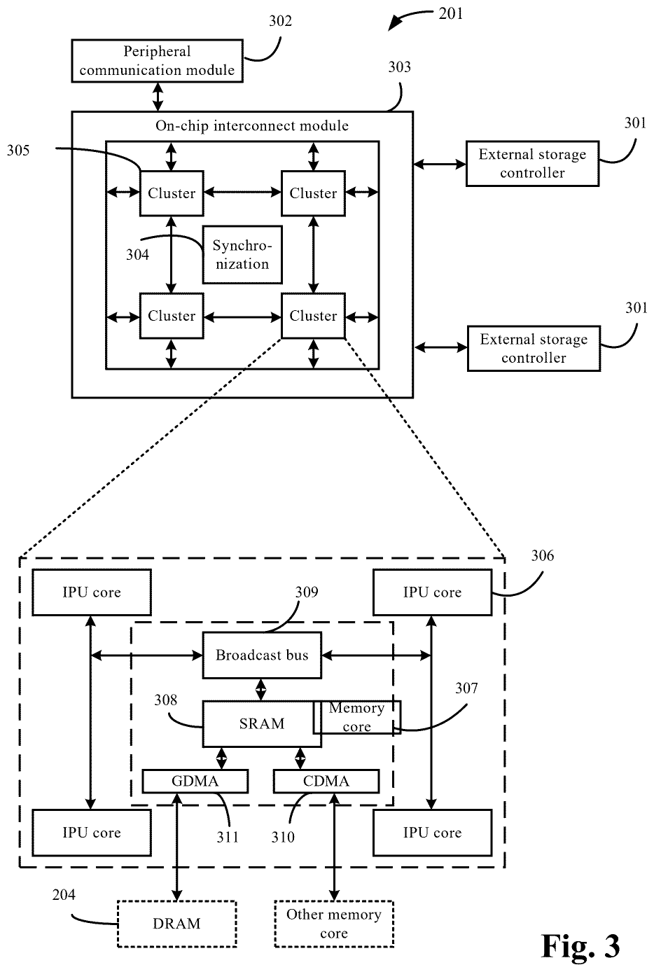

FIG. 3 illustrates a schematic diagram of the internal structure of the computing apparatus 201. The computing apparatus 201 is used to process input data such as computer vision, speech, natural language, data mining and the like. The computing apparatus 201 in the figure adopts a multi-core hierarchical structure design, which includes an external storage controller 301, a Peripheral communication module 302, an on-chip interconnect module 303, a synchronization module 304, and a plurality of clusters 305.

There may be a plurality of external storage controllers 301, two are exemplarily shown in the figure, and are configured to access an external storage device (for example, the DRAM 204 in FIG. 2) in response to an access request sent by a processor core, to read data from an off-chip or write data into the external storage device. The peripheral communication module 302 is configured to receive a control signal from the processing apparatus 203 via the interface apparatus 202, and start the computing apparatus 201 to execute a task. The on-chip interconnection module 303 connects the external memory controller 301, the peripheral communication module 302 and the plurality of clusters 305 to transmit data and control signals among the modules. The synchronization module 304 is a global barrier controller (GBC), and is configured to coordinate the work progress of each cluster to ensure information synchronization. The plurality of clusters 305 are the computational cores of computing apparatus 201. Four are exemplarily illustrated in the figure. With the development of hardware, the computing apparatus 201 of the present disclosure may also include eight, sixteen, sixty-four, or even more clusters 305. The plurality of clusters 305 is used to efficiently execute the depth learning algorithm.

Each cluster 305 includes a plurality of intelligent processing unit cores (IPU Cores) 306 and a memory core (MEM Core) 307.

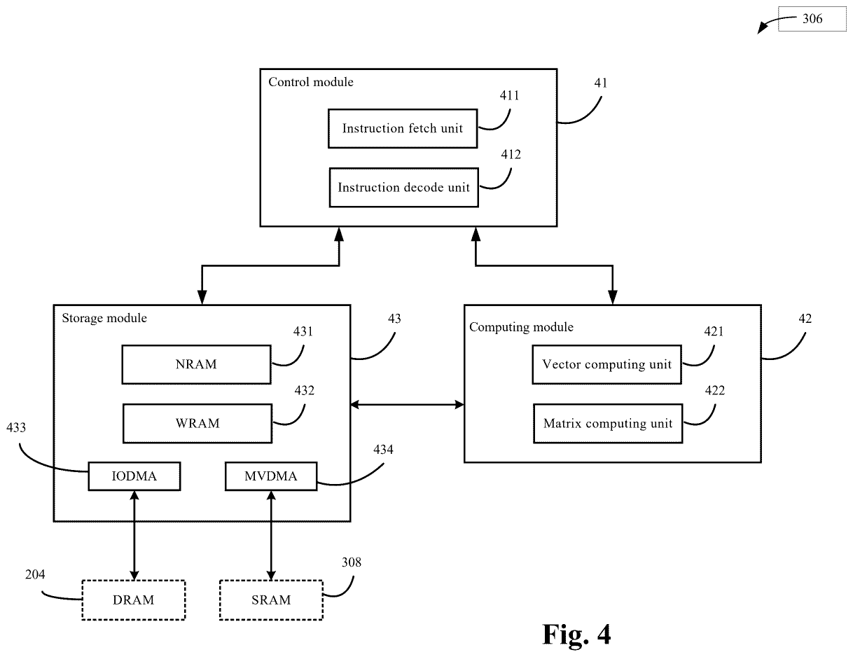

The IPU core 306 is illustrated exemplarily in the figure as four, and the present disclosure does not limit the number of IPU cores 306. Its internal architecture is shown in FIG. 4. Each IPU core 306 includes three major modules: a control module 41, a computing module 42 and a storage module 43.

The control module 41 is configured to coordinate and control the work of the computing module 42 and the storage module 43 to complete a task of depth learning, and the control module 31 includes an instruction fetch unit (IFU) 411 and an instruction decode unit (IDU) 412. The instruction fetch unit 411 is used to fetch instructions from the processing apparatus 203, and the instruction decoding unit 412 decodes the fetched instructions and sends the decoding results as control information to the computing module 42 and the storage module 43.

The computing module 42 includes a vector computing unit 421 and a matrix computing unit 422. The vector computing unit 421 is used to perform vector computation and may support complex computations such as vector multiplication, addition, nonlinear transformation and so on; the matrix computing unit 422 is responsible for the core computations of the deep learning algorithm, for example, matrix multiplication and convolution.

The storage module 43 is used to store or transport related data, including an neuron RAM (NRAM) 431, a weight RAM (WRAM) 432, an input/output direct memory access (IODMA) 433, and a move direct memory access (MVDMA) 434. The NRAM 431 is used to store input, output data and intermediate results for computation by the IPU core 306; the WRAM 432 is used to store the weights of the deep learning network; the IODMA 433 controls memory access between the NRAM 431/the WRAM 432 and the DRAM 204 through the broadcast bus 309; the MVDMA 434 is used to control memory access between the NRAM 431/the WRAM 432 and the SRAM 308.

Returning to FIG. 3, the memory core 307 serves primarily to store and communicate, in other words, to store shared data or intermediate results among the processor cores 306, as well as to perform communications between the cluster 305 and the DRAM 204, communications among the computing clusters 305 to each other, communications among the processor cores 306 to each other, and so forth. In other embodiments, the memory core 307 has the capability of scalar operations to perform scalar operations.

The memory core 307 includes a shared memory (SRAM) 308, a broadcast bus 309, a cluster direct memory access (CDMA) 310, and a global direct memory access (GDMA) 311. The SRAM 308 plays the role of a high-performance data relay station. The data reused between different processor cores 306 within the same cluster 305 does not need to be obtained from the DRAM 204 by each processor core 306, but is relayed between processor cores 306 through the SRAM 308. The memory core 307 only needs to quickly distribute the reused data from the SRAM 308 to the multiple processor cores 306 to improve the efficiency of inter core communication and greatly reduce on-chip and off chip input/output access.

The broadcast bus 309, the CDMA 310, and the GDMA 311 are respectively used to perform communication between the processor cores 306, communication between the clusters 305, and data transmission between the clusters 305 and the DRAM 204. The following will explain them separately.

The broadcast bus 309 is used to complete high-speed communication between the processor cores 306 in the cluster 305. The broadcast bus 309 of this embodiment supports inter-core communication modes including unicast, multicast and broadcast. Unicast refers to point-to-point (in other words, from a single processor core to a single processor core) data transmission, multicast is a communication mode of transmitting a piece of data from the SRAM 308 to specific several processor cores 306, and broadcast is a communication mode of transmitting a piece of data from the SRAM 308 to all processor cores 306, which is a special case of multicast.

The CDMA 310 is used to control the memory access of the SRAM 308 between different clusters 305 in the same computing apparatus 201. The GDMA 311 cooperates with the external memory controller 301 to control the memory access of the SRAM 308 of the cluster 305 to the DRAM 204, or reads data from the DRAM 204 to the SRAM 308.

The “inter-chip” mentioned in the present disclosure includes multiple meanings. First, “machine” usually refers to the server computing node host, and “inter-machine communication” may refer to the communication between multiple computing node hosts. “Card” usually refers to a dedicated artificial intelligence (AI) computing device installed on a server computing node, and the “card” has one or more chips, such as machine learning unit (MLU) and graphics processing unit (GPU). A “machine” usually has multiple “cards”, and a distributed training may involve multiple “machines” and multiple “cards” and “chips”. There are high-speed inter-chip interconnection communication devices between multiple machines and multiple cards, such as an inter-chip communication network built based on Serdes (serial-deserialization) and a host-level network based on Infiniband. In the present disclosure, inter-chip communication includes communication between different chips between multiple hosts, communication between different chips on the same “card”, and communication between different chips in multiple cards on the same host.

Remote direct memory access (RDMA) refers to remote DMA, in other words, a card A may asynchronously write/read data to the memory of a card B without the card B performing any operation.

Allreduce operator: in the process of multi-machine multi-card neural network training, in order to ensure the convergence of the data concurrent training results of multi-machine multi-card, each device participating in the distributed training needs to pass the gradient information ΔWᵢ of the current device back propagation (BP) to other devices, so that each device can finally obtain the reduced result of all gradient information, for example, ΣΔWᵢ. The method of propagating and accumulating gradient information is called the AllReduce operator.

Ring Allreduce algorithm: The Allreduce operator can be implemented on different network topologies. The Allreduce operator optimized for the ring topology uses the Ring Allreduce algorithm. From the perspective of a single card, the core processes that Allreduce needs to implement are: Receive (abbreviated as R), Compute (abbreviated as C), and Send (abbreviated as S). In the Ring Allreduce algorithm, the R part corresponds to receiving the gradient information ΔW_(i−1) sent by the upstream device, the C part corresponds to calculating ΔW_(i)=Add (ΔW_(i−1), ΔW_(i)), and the S part corresponds to sending the updated gradient information ΔW_(i) to the downstream device.

Synchronization problem: In the RDMA mode, the computing core of the card A writes data load to the memory area of the card B. At this time, the computing core of the card B cannot sense whether the data load has been written. At this time, if the subsequent execution steps of the computing core of the card B depend on the arrival of the data load to continue execution, the computing core of the card B needs to sense the arrival of the data load. The process of sensing the arrival of the data load is called communication synchronization.

The communication deadlock problem: If there is a computing core on the card A and the card B respectively, and there are two dual-card communication tasks X and Y, which are sent to the two cards respectively as X_A, X_B and Y_A, Y_B. The communication task requires that both ends of the communication must be the same task in order to communicate normally. There is a moment when the computing core on the card A is occupied by X_A and the computing core on the card B is occupied by Y_B. At this time, both X_A and Y_B fall into communication synchronization and poll for data to arrive. But in fact, because the tasks do not match, communication tasks X and Y will wait forever, causing the communication deadlock.

Currently, communication synchronization usually involves the following solutions.

The first solution is polling: hardware multi-threaded programming method (Single Instruction, Multiple Threads, SIMT). The specific communication synchronization steps are as follows:
Step a, a device A writes data to the specified memory area of a device B in sequence through RDMA, and writes a flag.
Step b, the computing core of the device B polls whether the flag has changed in the communication receiving task. If the flag has never changed, the process goes to step c; if the flag has changed, the process goes to step d.
Step c, if the flag has never changed, it means that the data has not yet completed the transmission. At this time, the thread may be switched out of the current processing due to invalid waiting, and the computing core processing is released to other computing/communication tasks. The specific hardware multi-threading method is to save a scene (including the current execution pointer of the program, stack information, and register information) when the thread is switched out, recover the scene when the thread is switched back, and resume execution from the thread breakpoint. When the thread resumes execution, if the flag is read to have changed, the process goes to step d, otherwise continues to poll in step c.
Step d, if the flag has changed, it means that the data has been transmitted. At this time, the computing core of the device B may safely read the data, such as performing reduce calculations.

The first solution is mainly based on the SIMT implementation, which requires hardware multiple threads support execution. The advantage is that software developers write multiple threads kernels from the perspective of warp and are not aware of switching.

The second solution, which is an interrupt type, may be found in the Chinese patent application with publication number CN114691312A. Specifically, the specific communication synchronization steps of the above interrupt type are as follows:
Step a, a device A writes a hardware descriptor and data to a device B through RDMA.
Step b, a device B receives the hardware descriptor, which means that the data has been received. The data reception is completed and an interrupt causes the hardware to parse the hardware descriptor, and then triggers the computing core to perform computing tasks according to the content of the hardware descriptor, such as performing reduce calculations.

The second solution is mainly based on the SIMD implementation, which supports computing core reuse through software, and only requires minimal hardware changes, thereby avoiding a large number of hardware replacements or changes.

The detailed embodiments of the present disclosure will be described below in conjunction with the accompanying drawings.

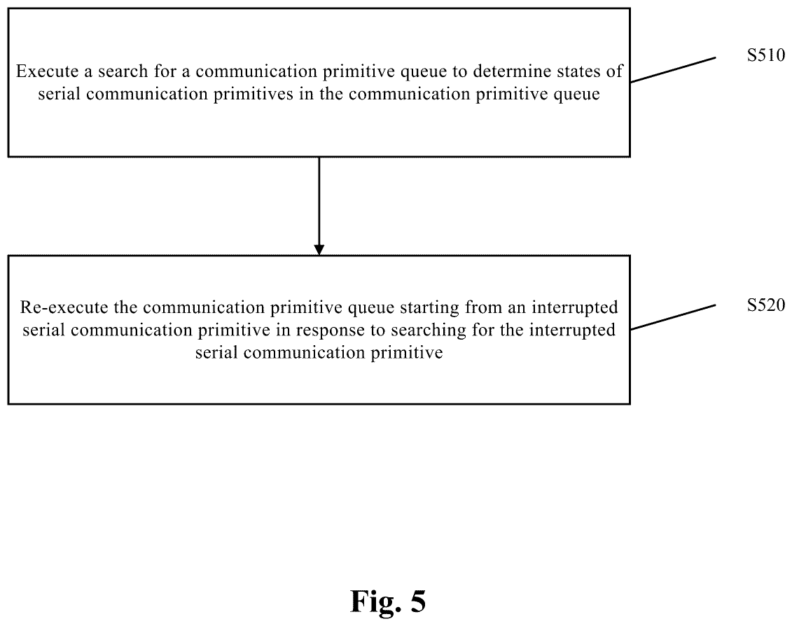

FIG. 5 shows a method for executing an inter-chip communication task according to an embodiment of the present disclosure, where the inter-chip communication task is described by a communication primitive queue, the communication primitive queue includes a plurality of communication primitives, and the plurality of communication primitives include serial communication primitives connected in series. The method includes: in the S510, executing a search for the communication primitive queue to determine states of the serial communication primitives in the communication primitive queue; in the S520, in response to searching for an interrupted serial communication primitive, re-executing the communication primitive queue starting from the interrupted serial communication primitive.

First, the above technical features of the present disclosure are executed in a “coroutine” mode. Coroutine is a non-preemptive scheduling mechanism in which the software itself actively wakes up and sleeps. In contrast, threads are preemptive scheduling mechanisms where the software is passively awakened and put to sleep by the operating system and hardware scheduling.

For example, in a multi-threaded mode, the code may be:

```
int thread( ) {
    x = read(X);
    while(x != 10) {
      x = read(X);
    }
  }
```

In the above code, under the hardware multithreading, the thread will be automatically switched out by the operating system to execute other functions during the process such as read (X) due to the expiration of the time slice, and will resume execution after a period of time. The thread is not aware of the switching out and switching in process.

In a coroutine mode, the code may be:

```
int thread( ) {
    x = read(X);
    while(x != 10) {
      x = read(X);
      sleepAndWakeUpNext( );
    }
  }
```

In the coroutine mode, the coroutine will actively sleep and wake up other functions in a sleep state.

For the wake-sleep coroutine mode, the Chinese patent application with publication number CN114691312A may be referred.

During the communication process, taking Ring AllReduce as an example, the communication primitives such as SEND, RecvReduceSEND, RecvReduceCopySEND, RecvCopySEND, and Recv will be executed, which may be abbreviated as OP in the present application. It should be understood that in the present application, there is no essential difference between the two description methods of the communication primitives and OP, but it is only to match the context at the time.

The communication primitives disclosed in this disclosure may beasynchronous communication primitives. The asynchronous communication primitives may have the following characteristics.

Asynchronicity: the execution of the communication primitives is asynchronous, in other words, when the communication primitive function returns, the communication operation represented by the communication primitive may still be executing on the hardware until an asynchronous response is received to confirm that the communication primitive is completely completed.

Non-idempotent: repeated execution of a communication primitive may lead to incorrect execution results, so the communication primitive cannot usually be executed twice, unless the previous communication primitive is not fully executed due to a communication error.

Unreliable: the communication primitive may cause communication packet loss due to problems such as link quality, so the communication primitive needs to re-execute the transmission of the lost part.

In the present disclosure, a communication primitive queue may be used to describe inter-chip communication tasks. These communication tasks may be executed in series or in parallel. For the convenience of description, communication primitives connected in series are referred to as serial communication primitives, and communication primitives connected in parallel are referred to as concurrent communication primitives in the present disclosure. A communication queue may include a plurality of serial communication primitives, or a mixture of serial communication primitives and concurrent communication primitives, which will be described in more detail later.

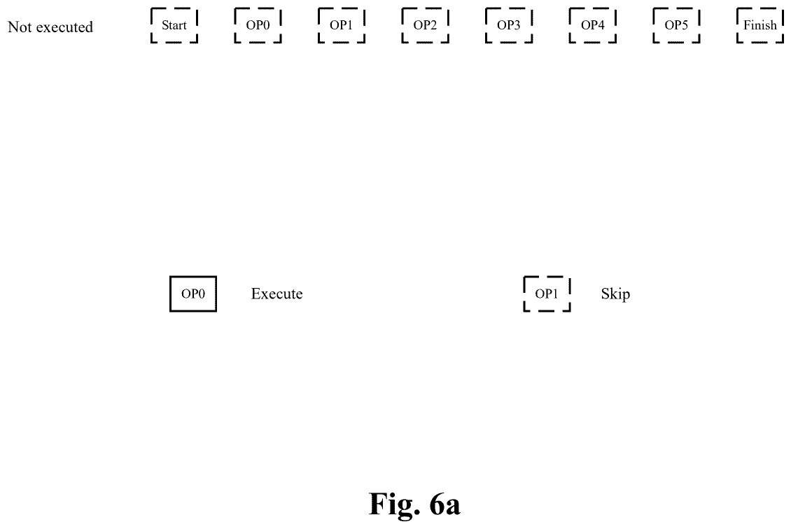

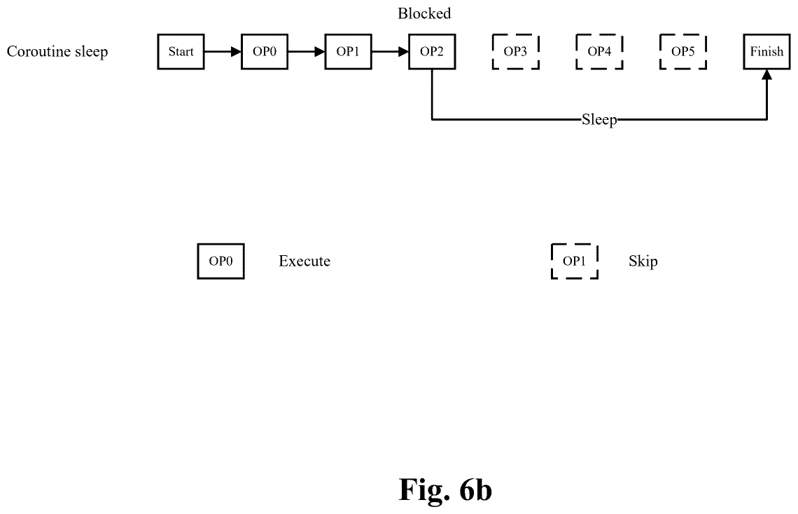

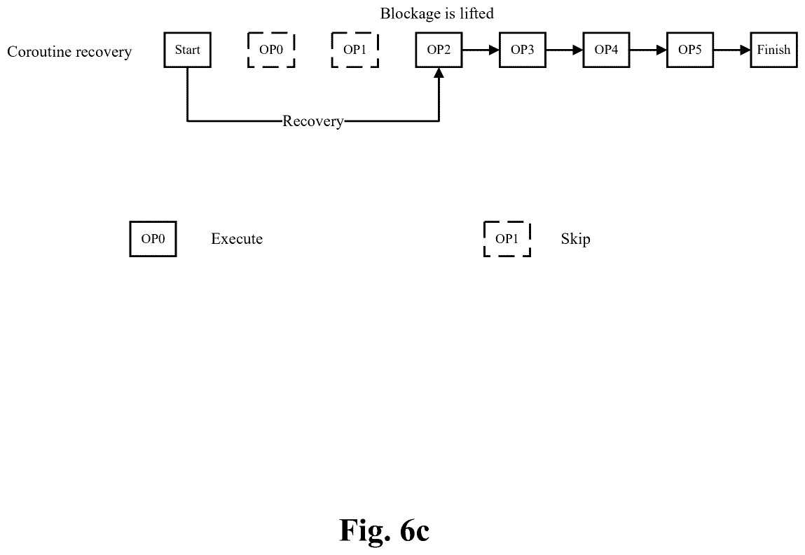

FIG. 6 illustrates an example of coroutine execution according to an embodiment of the present disclosure.

In FIG. 6, the communication process may be abstracted as a serial execution process of a string of communication primitives OP, the initial state of which is Start and the termination state is Finish. Under normal circumstances, if no communication blockage is encountered, the coroutine operation will execute communication primitives OP0 to OP5 one by one from Start until it reaches FINISH. It should be noted that, for the sake of easy identification, in FIG. 6, the communication primitives OP that are skipped and not executed are marked with dotted boxes, and the communication primitives OP that are actually executed are represented by solid boxes.

But in fact, in real communication, “a communication blockage” is usually encountered. At this time, the computing core actively calls Sleep to exit, and the variables involved in the scene reside in a specific storage space area. As shown in “Coroutine sleep” in FIG. 6, assuming that the execution of communication primitives OP0 and OP1 is successfully completed, but the communication primitive OP2 is currently blocked, the subsequent communication primitives OP3, OP4, and OP5 will no longer be executed. At this time, the computing core may switch to perform other communication tasks.

As shown in “Coroutine recovery” in FIG. 6, when “blockage is lifted”, in other words, when communication synchronization is completed, the communication primitive OP2 of the last Sleep may be continued to execute. If it is no longer blocked, it will be directly executed to Finish to end the task of the computing core.

In order to be able to continue the execution of the last communication primitive OP when the blockage is lifted, the software needs to perform context recovery by itself. The context recovery includes two parts of recovery.
1) Recovery of context data: the recovery of context data only needs to reload the content in a specific storage space area.
2) Recovery of program execution position: due to hardware simplification design considerations, the hardware does not support direct recovery to the position of the communication primitive OP when Sleep exits. Therefore, this solution designs a communication primitive jump mechanism.

Therefore, according to an embodiment of the present disclosure, in order to realize the above-mentioned jump mechanism, the method of the present disclosure further includes: defining a state machine, where the state machine is used to describe the work state of the communication primitive; and determining whether the communication primitive is interrupted according to the working state of the communication primitive described by the state machine, where the working state includes: pending state; working state; executed state; and confirmed state.

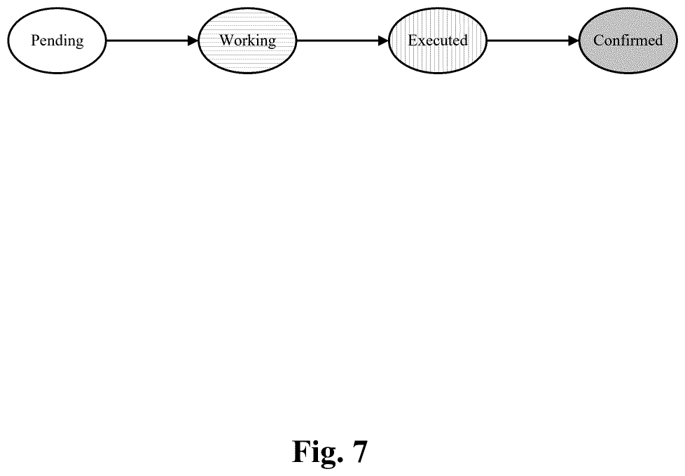

FIG. 7 illustrates possible changes in the work state of a communication primitive (OP).

As shown in FIG. 7, when a communication primitive OP is not executed, it is in the Pending state, which is used to indicate that the communication primitive has not been executed. All communication primitives OP may be in the Pending state initially until the state changes after being executed.

The Working state, which is after the Pending state, is used to indicate that the communication primitive is being executed, the communication request of the communication primitive has not been completely issued, and the response signal has not been completely received. In other words, it refers to the state of the OP when the computing core executes the communication primitive OP. For a single computing core, at most one communication primitive is in the “Working” state. In the “Working” state, the communication primitive OP has not completely issued the communication request to other communication primitives, and has not completely received the response signal. Under normal circumstances, the state of all communication primitives OP will change from the Pending state to the Working state, unless the execution of the OP is skipped.

The executed state (Executed), after the “Working” state, is used to indicate that the communication primitive has been executed, the communication request of the communication primitive has been completely issued, and the response signal has not been completely received. After a communication primitive OP is executed and a communication request is completely issued, the communication primitive OP will wait for a response signal for the communication request. However, in many cases, the communication primitive OP may not receive a response signal, or the reception of the response signal may be delayed. These cases include but are not limited to the following: the request signal issued does not reach the downstream communication primitive OP (for example, due to a communication line failure); the request signal issued reaches the downstream OP, but the signal of the downstream OP does not issue a response signal (for example, the downstream OP fails), or the downstream OP issues a response signal, but the OP that issues the communication request does not receive the response signal (for example, the communication line fails). The above only illustrates several example situations where the OP does not receive a response signal. Many other types of failures may also cause the OP to not receive a response signal, which will not be exhaustively listed here.

The Confirmed state, after the Executed state, is used to indicate that the communication request of the communication primitive has been completely issued and the response signal has been completely received. The Confirmed state is the last state of the four states in the present disclosure.

In the present disclosure, it is assumed that all communication primitives are in a Pending state. Then, when the communication primitive queue is started, if no interruption occurs, each communication primitive in the queue enters the Working state one by one from the Pending state. It should be understood that the term “one by one” here means the serial execution of the communication primitives, in other words, for a single computing core, at most one communication primitive is in the Working state. In other words, when the computing core is executing a communication primitive, other communication primitives are not executed at the same time, but the next communication primitive is executed only after exiting the execution of a communication primitive.

According to the embodiment of the present disclosure, the work state is switched according to the execution of the communication primitive, wherein the switching of the work state is unidirectional.

In the embodiment of the present disclosure, the communication primitive is converted in the order of the Pending state, the Working state, the Executed state and the Confirmed state, in other words, the state of the communication primitive may only be converted from the Pending state to the Working state, from the Working state to the Executed state, and from the Executed state to the Confirmed state, but cannot be converted in the opposite direction.

It should also be understood that the “state” described in the present disclosure has two meanings, in other words, the state of the communication primitive and the state of the state machine. The change of the state of the communication primitive may cause the state of the state machine to change accordingly, but in practice, the change of the state of the state machine is not necessarily synchronized with the state of the communication primitive. For example, the state machine periodically scans the queue of communication primitives, thereby updating its own state according to the state of the scanned communication primitives. In this case, the state of the communication primitive may have changed, but the state of the state machine may not have changed. In addition, since there may be a certain time interval for scanning the state of the communication primitive, the state change in the state machine may jump, for example, it may jump directly from the “Pending” state to the “Executed” state, or it may jump to the “Confirmed” state, while the state of the communication primitive itself cannot jump.

In addition, according to the embodiment of the present disclosure, in the communication primitive queue, the work state of the subsequent serial communication primitive is prohibited from being after the work state of the previous serial communication primitive; in other words, the work state of the previous serial communication primitive is prohibited from being before the work state of the subsequent serial communication primitive.

Still taking FIG. 6 and FIG. 7 as examples, assuming that communication primitives OP1 to OP5 are communication primitives that are executed serially and in sequence, in this embodiment, if the communication primitive OP3 in the “Executed” state is used as a reference, then the communication primitives OP1 and OP2 before the communication primitive OP3 may be in the Executed state or the Confirmed state, but are prohibited from being in the Pending state or the Working state, in other words, the states of the communication primitives OP1 and OP2 before the communication primitive OP3 cannot be before the state of the communication primitive OP3; and the communication primitives OP4 and OP5 after the communication primitive OP3 may be in the Pending state, the Working state or the Executed state, but may not be in the Confirmed state, in other words, the states of the communication primitives OP4 and OP5 after the communication primitive OP3 may not be after the state of the communication primitive OP3.

It should be noted that the above paragraph is explained only taking the communication primitive OP3 as a reference, and the above rules must be followed in the entire communication primitive queue. In addition, it should be noted that, as described above, only one communication primitive is in the Working state. Therefore, in the serial communication primitive queue, the communication primitive before the communication primitive in the Working state needs to be in the Executed state or the Confirmed state, and may not be in the Working state at the same time.

According to the above implementation, the state of the communication primitive will not be reversed, so that it is convenient to put the execution of the communication primitive queue into sleep when a communication primitive is blocked.

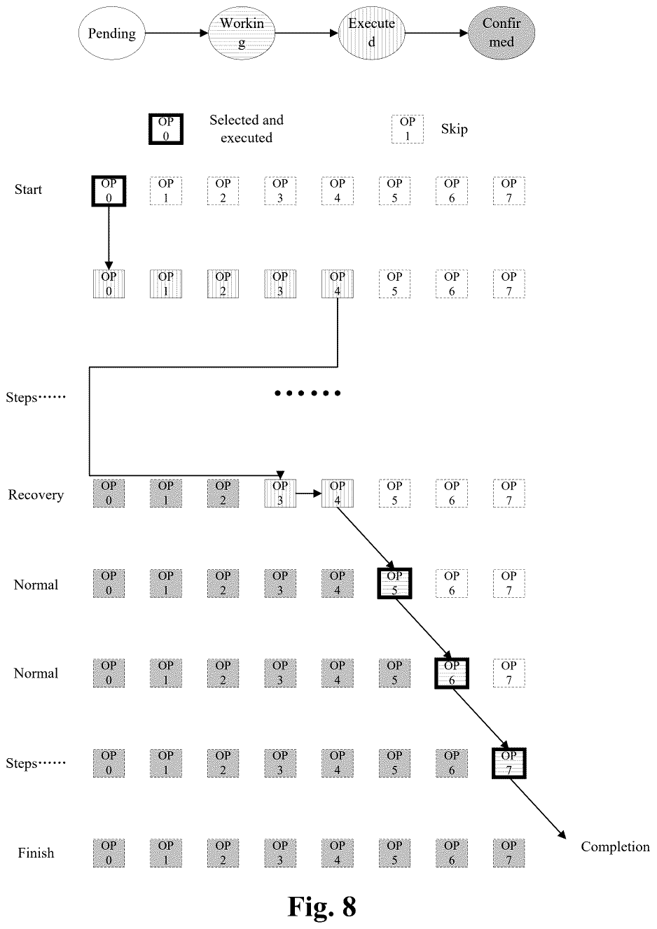

FIG. 8 illustrates a schematic diagram of execution situation of a serial primitive queue according to an embodiment of the present disclosure. In FIG. 8, in order to distinguish different states, different backgrounds are used for distinction, for example, the “Pending” state is represented by a blank background, the “Working” state is represented by a horizontal line background, the “Executed” state is represented by a vertical line background, and the “Confirmed” state is represented by a gray background. In addition, the skipped OP is represented by a dotted line box, the executed OP is represented by a solid line box, and the currently selected and being executed OP is represented by a bold solid line box.

According to one embodiment of the present disclosure, the method of the present disclosure further includes: in response to a communication blockage occurring in a serial communication primitive, exiting the execution of the communication primitive queue at the serial communication primitive where the communication blockage occurs.

In step a, as shown in the line “start” in FIG. 8, first, an OP in a “Pending” state is searched for from front to back, and the OP is converted into a “Working” state, and if the OP is executed, the OP is converted into an “Executed” state. Thus, the above step a is repeatedly executed until the communication blockage occurs. As shown in FIG. 8, assuming that a communication blockage occurs at the OP3, a sleep operation is performed at the OP3. Then, after the hardware wakes up the communication primitive queue, step b is executed. As shown in FIG. 8, after a period of execution, the OP0-OP4 may all be in the “Executed” state, while the OP5-OP7 are still in the “Pending” state because they are not selected for execution. According to one embodiment of the present disclosure, the method further includes: in response to a communication blockage occurring in a serial communication primitive, the work state of the corresponding serial communication primitive being maintained in the Executed state.

After running for a period of time, the OP0-OP3 all have successfully received the response signal, so they entered the “Confirmed” state, and the communication blockage occurs at the OP3, so the sleep operation is performed at the OP3. According to the above, the work state of the subsequent serial communication primitive is prohibited from being after the work state of the previous serial communication primitive, so the work state of the OP4 is also in the “Executed” state, and cannot proceed to the “Confirmed” state.

In step b, when waiting to be reawakened, in other words, when recovering, it may be determined that some OPs have been converted to the “Confirmed” state (the OP0-OP2 in the “Recovery” line) due to asynchronous confirmation. The OP in the “Executed” state is searched from front to back because this part of the OP has a communication error and needs to be re-executed (the OP3-OP4 in the “Recovery” line). When all “Executed” state OPs have been searched (the OP5 in the “Recovery” line), step a is repeated. If all OPs are in the “Confirmed” state, step c is entered.

It may be understood that after recovery, if the execution of all communication primitives is normal, the next OPs (such as OP5 to OP7) will be executed one by one until all OPs are executed.

In step c, at this time, all OPs have been executed and the asynchronous operation has been confirmed to return, then the end state (last line) may be entered.

The above is a schematic diagram of the state changes of different OPs as the execution proceeds in combination with FIG. 8. According to one embodiment of the present disclosure, when the execution of OP is recovered, for example, as shown in FIG. 8, when the execution of OP is recovered from the OP3, starting from the serial communication primitive where the interruption occurs, re-executing the communication primitive queue includes the following: for the serial communication primitive that has been partially executed, only the part of the serial communication primitive that has not been executed is re-executed.

It may be understood that, as described above, for the communication primitive queue, the communication primitives that have been executed and are in the “Confirmed” state will no longer be executed when the communication primitive queue is recovered, and only those communication primitives that have not been executed or have been incompletely executed will be executed. According to the preferred embodiment of the present disclosure, for a certain communication primitive, if the communication primitive is blocked after a part of it is executed, the execution of the communication primitive is incomplete; then, for the incompletely executed communication primitive, the part that has been executed will no longer be executed, and only the part that has not been executed will be executed.

Such beneficial effects include several aspects. For instance, only executing the part of the communication primitive that has not been executed is conducive to reducing the repeated execution of the communication primitive and improving the efficiency during recovery.

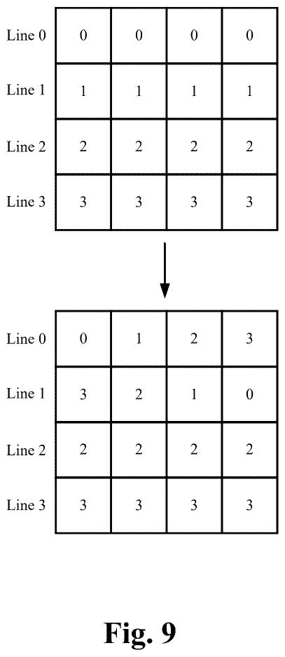

In addition, for in-place operation, only executing the part of the communication primitive that has not been executed may avoid data errors. In-place operation means that the operation occurs at the storage location where the data involved in the operation is originally located. FIG. 9 illustrates a schematic diagram of a communication primitive involving in-place operations.

As shown in FIG. 9, assuming that the original data of an in-place operation includes a 4*4 data matrix, the 0th line is data {0, 0, 0, 0}, the 1st line is data {1, 1, 1, 1}, the 2nd line is data {2, 2, 2, 2}, and the 3rd line is data {3, 3, 3, 3}. When performing in-place operations, the above original data will be overwritten. Assuming that these original data have only undergone partial operations, and the original data of lines 0 and 1 are overwritten by new data, for example, the new data are {0, 1, 2, 3} and {3, 2, 1, 0} respectively, but the data of lines 2 and 3 are not operated due to a communication blockage, and the original data is still retained. In this case, if all data are still operated upon during recovery, an error may occur because the data has been updated, whereas if only the part that has not been executed is executed, the above error will not occur.

The above describes the scenario of serial execution between a plurality of OPs, but there may also be a situation where the plurality of OPs are executed concurrently.

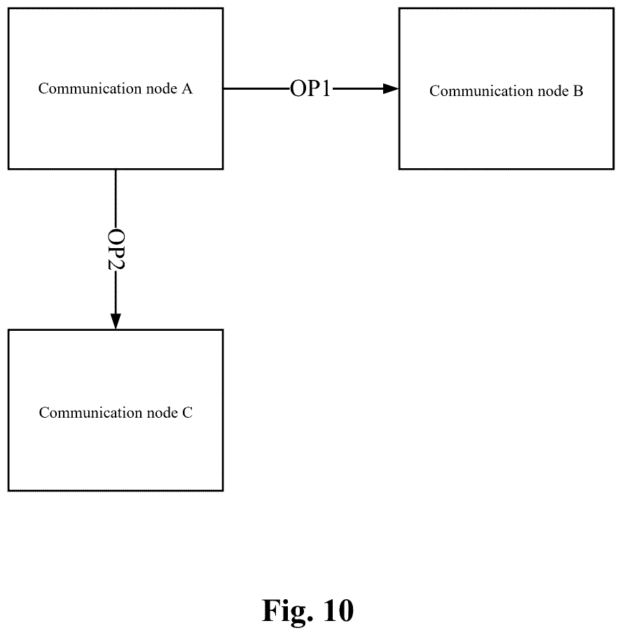

FIG. 10 illustrates an exemplary application scenario in which there are a plurality of concurrent communication primitives.

As shown in FIG. 10, there is a connection relationship between the upstream communication node A and the two downstream communication nodes B and C, and the communication primitive OP1 is executed between the communication nodes A and B, while the communication primitive OP2 is executed between the communication nodes A and C. These are two concurrent communication primitives, because the two communication primitives OP1 and OP2 use different communication paths and do not interfere with each other. In this case, the concurrent execution of the communication primitives can be achieved through the aforementioned coroutine and primitive jump mechanism. According to one embodiment of the present disclosure, concurrent execution means that different communication primitives may be executed alternately, thereby achieving a multi-thread-like execution mode within a single core. Through this mechanism, a single computing core may be used to complete the concurrent execution of a plurality of different communication primitives, and a plurality of different computing cores are not required.

According to one embodiment of the present disclosure, the plurality of communication primitives further include concurrent communication primitives that can be executed concurrently, and the method further includes: executing the concurrent communication primitives in a time-division manner.

It should be understood that the “concurrency” mentioned here does not mean execution at the same time, but may be a concurrent execution of communication primitives in the form of time-separated or time-division multiplexing.

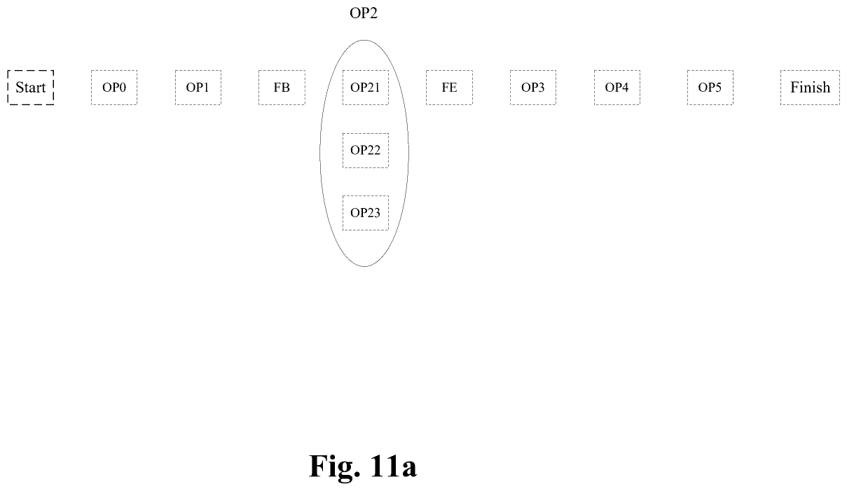

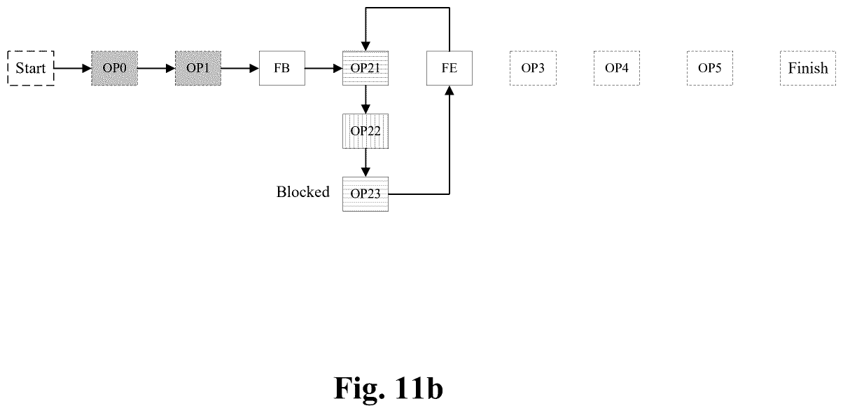

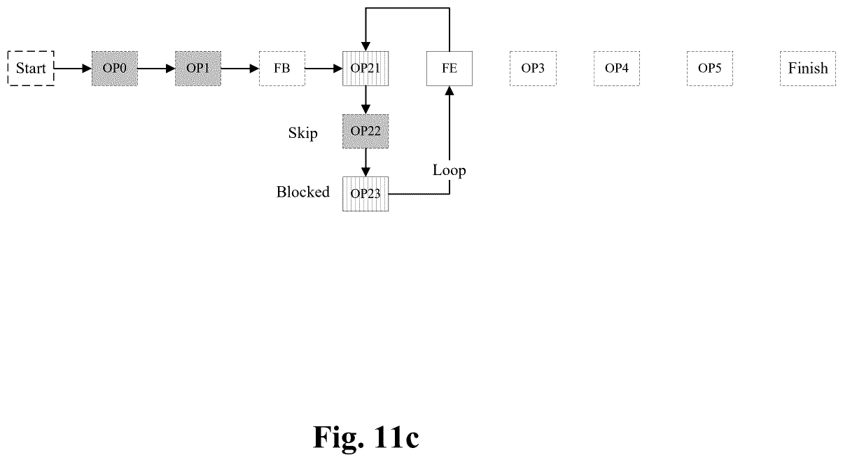

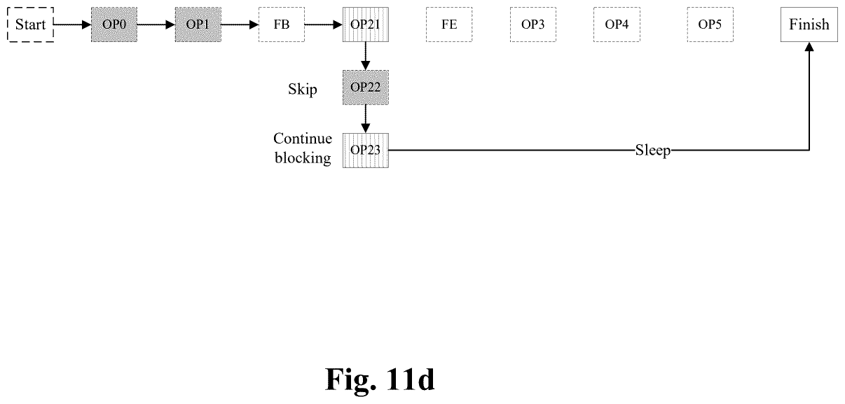

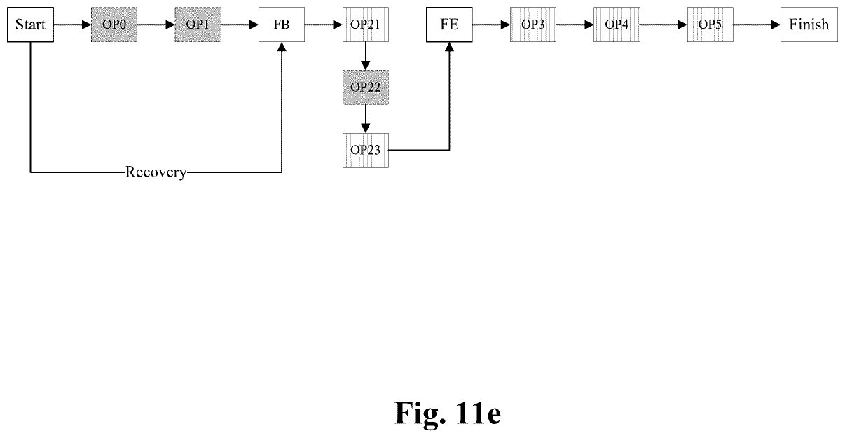

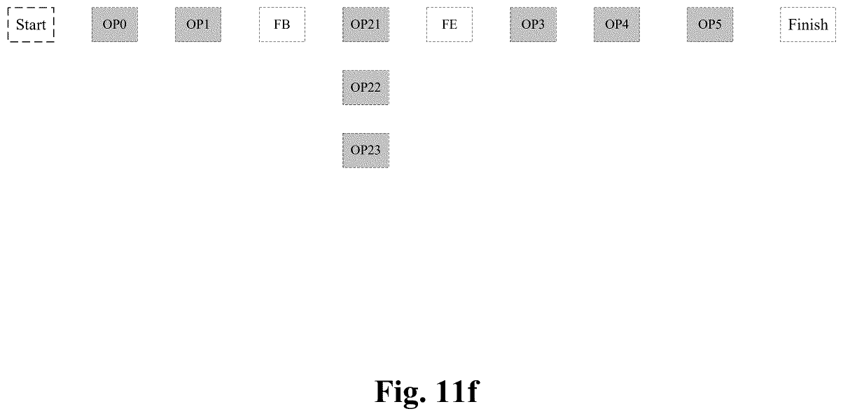

FIG. 11a to FIG. 11f illustrate schematic diagrams of setting concurrent communication primitives among serial communication primitives according to an embodiment of the present disclosure. Among them, similar to FIGS. 7 and 8, in order to distinguish different states, different backgrounds are used for distinction. For example, the “Pending” state is represented by a blank background, the “Working” state is represented by a horizontal line background, the “Executed” state is represented by a vertical line background, and the “Confirmed” state is represented by a gray background. In addition, the skipped OP is represented by a dotted line box, and the executed OP is represented by a solid line box. It should be understood that the boxes “Start”, “Finish”, “FB” and “FE” are all represented by a blank background, but they only represent some key points of OP execution, and do not necessarily participate in the execution of OP.

According to one embodiment of the present disclosure, the method of the present disclosure further includes: inserting a concurrent start identifier between the concurrent communication primitive and the previous serial communication primitive, so that when the communication primitive queue executes to the concurrent start identifier, the concurrent communication primitive is executed in time-division; and inserting a concurrent end identifier between the concurrent communication primitive and the next serial communication primitive, so that when the communication primitive queue executes to the concurrent end identifier, the concurrent communication primitive is re-executed according to the state of the concurrent communication primitive, or the execution of the concurrent communication primitive is exited.

As shown in FIG. 11a, assuming that the OP0, the OP1, the OP3, the OP4 and the OP5 are the serial communication primitives mentioned above, there are three concurrent communication primitives the OP21, the OP22 and the OP23 between the OP1 and the OP3, where if the OP21, the OP22 and the OP23 are regarded as a whole (assuming they are represented as the OP2), then the OP0, the OP1, the OP2, the OP3, the OP4 and the OP5 still constitute a serial communication primitive queue, which still complies with the rules described above. However, if the OP21, the OP22 and the OP23 are treated separately, then the OP21, the OP22 and the OP23 may be executed in time-division.

The difference between concurrent communication primitives the OP21, the OP22 and the OP23 and serial communication primitives the OP0, the OP1, the OP3, the OP4 and the OP5 is that when executing a serial communication primitive, if communication is blocked, the blocked serial communication primitive will be put into sleep mode; while when executing a concurrent communication primitive, the blockage of one concurrent communication primitive does not affect the execution of other concurrent communication primitives.

Still as shown in FIG. 11a, in order to distinguish between serial communication primitives and concurrent communication primitives, an identifier may be inserted between the two to distinguish them, thereby adopting different execution modes. Specifically, a concurrent start identifier Flag Begin (FB) may be inserted between the serial communication primitive the OP1 and the concurrent communication primitives the OP21, the OP22 and the OP23. When the concurrent start identifier FB is executed, the communication primitives after the concurrent start identifier FB may be automatically executed concurrently. Similarly, a concurrent end identifier Flag End (FE) may be inserted between the concurrent communication primitives the OP21, the OP22 and the OP23 and the serial communication primitive OP3. When the concurrent end identifier FE is executed, it means the end of the execution of this concurrent communication primitive.

It should be understood that the “end of the execution of this concurrent communication primitive” mentioned above does not mean to exit the execution of all concurrent primitives, but may be executed again, in other words, to re-execute the concurrent communication primitive with blockage, or to exit the execution of the concurrent communication primitive.

FIG. 11a illustrates the states of all communication primitives and their relationship when they are not executed, where all communication primitives OP are in a pending state, represented by a dotted line box. FIG. 11b illustrates a schematic diagram of executing concurrent communication primitives a plurality of times.

According to one embodiment of the present disclosure, executing the concurrent communication primitive in time-sharing includes: making the concurrent communication primitive alternately enter the Working state from the Pending state.

As shown in FIG. 11b, assuming that the serial communication primitives OP0 and OP1 have been executed and are in the “Confirmed” state, after the concurrent start identifier FB, the execution of the concurrent communication primitives OP21, OP22 and OP23 occurs. This enables the OP21 to OP23 to alternately (or in a time-division manner) enter the “Working” state. However unlike the execution of the serial communication primitive, the concurrent communication primitives OP21 to OP23 are concurrent, and therefore their states are independent of each other. For example, as shown in FIG. 11b, after the concurrent communication primitives the OP21 to the OP23 are executed for the first time, the OP21 may be in the “Working” state, OP22 may be in the “Executed” state, and the OP23 may be in the “Working” state. Assuming that the concurrent communication primitive OP2 is blocked at this time, the communication primitive may be re-executed according to the following methods and rules.

According to an embodiment of the present disclosure, according to the state of the concurrent communication primitive, re-executing the concurrent communication primitive includes: in response to not all of the concurrent communication primitives experiencing a communication blockage, re-executing the concurrent communication primitive.

Taking FIG. 11b as an example again, since the communication primitive OP22 does not experience a communication blockage, according to one of the rules of this disclosure, when the concurrent communication primitives OP21, OP22, and OP23 have not all experienced blockage, the blocked communication primitives OP21 and OP23 may be executed again. Specifically, after the concurrent communication primitive OP23 is executed, the process enters the concurrent end identifier FE, and returns to the concurrent communication primitive OP21 again, so that the concurrent communication primitive that was blocked last time is re-executed.

According to an embodiment of the present disclosure, re-executing the concurrent communication primitive includes: for the concurrent communication primitive that has been partially executed, only the part of the concurrent communication primitive that has not been executed is re-executed.

As described above, for a certain communication primitive, if the communication primitive is blocked after executing a part, the execution of the communication primitive is incomplete. Then, for the incompletely executed communication primitive, the part that has been executed will no longer be executed, and only the part that has not been executed will be executed.

Such beneficial effects include several aspects. For instance, only executing the part of the communication primitive that has not been executed is conducive to reducing the repeated execution of the communication primitive and reminding the efficiency of recovery.

In addition, the above describes the beneficial effects of only executing the part that has not been executed in some specific situations in combination with FIG. 9, and such beneficial effects are also applicable to concurrent communication primitives.

According to one embodiment of the present disclosure, according to the state of the concurrent communication primitive, re-executing the concurrent communication primitive further includes: skipping the concurrent communication primitive in the Confirmed state without re-executing.

As shown in FIG. 11c, assuming that when concurrent communication primitives OP21, OP22 and OP23 are re-executed, concurrent communication primitive OP22 is already in the “Confirmed” state, and a communication blockage occurs at concurrent communication primitives OP21 and OP23 and they are in the “Executed” state, then the execution of concurrent communication primitive OP22 is skipped, and only concurrent communication primitives OP21 and OP23 are executed alternately again.

It should be understood that when the concurrent communication primitives OP21, OP22 and OP23 are re-executed, in the above example, the OP22 being in the “Confirmed” state is merely one implementation method, and it is not necessary for it to be in the “Confirmed” state in order to be skipped. Essentially, as long as the execution of the concurrent communication primitive does not encounter a communication blockage, even if it is not in the “Confirmed” state during the second round of execution, the execution of that concurrent communication primitive is still skipped.

On the other hand, according to one embodiment of the present disclosure, exiting the execution of the concurrent communication primitive based on the state of the concurrent communication primitive includes: in response to a communication blockage occurring in all of the plurality of concurrent communication primitives, exiting the execution of the concurrent communication primitive and exiting the execution of the communication primitive queue.

In this case, if the communication blockage occurs in all of the three concurrent communication primitives OP21, OP22 and OP23 when the concurrent communication primitives OP21, OP22 and OP23 are executed alternately, resulting in all concurrent communication primitives being unable to execute normally, then in this case, the execution of these communication primitives may be exited and the sleep state may be entered. The OP21, OP22 and OP23 may be regarded as a serial communication primitive as a whole, which forms a serial relationship with the upstream serial communication primitive OP1 and the downstream OP3. Therefore, according to the above description, when the communication blockage occurs in a serial communication primitive, the execution may be exited from the currently blocked serial communication primitive.

Furthermore, according to one embodiment of the present disclosure, exiting the execution of the concurrent communication primitive based on the state of the concurrent communication primitive includes: in response to the number of times the concurrent communication primitive is re-executed reaching a predetermined number and the communication blockage occurring in at least one of the plurality of concurrent communication primitives, exiting the execution of the concurrent communication primitive and exiting the execution of the communication primitive queue.

According to the above embodiment of the present disclosure, after returning from the concurrent end identifier FE to the concurrent communication primitive for execution again, if the number of returns exceeds the predetermined number of times, when there is still communication blockage in the concurrent communication primitive, these concurrent communication primitives may not be returned, and exit from the communication primitive queue. For example, as shown in FIG. 11d, after returning from the concurrent end identifier FE to the concurrent communication primitive twice, if at least one of the concurrent communication primitives OP21, OP22 and OP23 (the OP21 and OP23 in FIG. 11d) is still in a blocked state, these concurrent communication primitives may not be returned, and exit from the communication primitive queue. Such a beneficial effect is that the execution of the concurrent communication primitive will not loop endlessly. When the problem cannot be solved after multiple attempts, the concurrent communication primitive will be exited normally, and the execution of the entire communication primitive queue will be exited to avoid deadlock.

A counter may be added at the concurrent end identifier FE. When the number of times the concurrent communication primitive is returned from the concurrent end identifier FE reaches the value specified by the counter, the concurrent communication primitive may be exited and sleep.

According to one embodiment of the present disclosure, in response to exiting the execution of the concurrent communication primitive, a recovery identifier is added at the concurrent start identifier to facilitate easy search for the exit position when recovering the execution of the communication primitive.

Still as shown in FIG. 11d, after the plurality of executions of concurrent communication primitives OP21, OP22, and OP23, some of these concurrent communication primitives still experience communication blockage and will exit from their execution. When exiting, in order to facilitate the smooth search for the exit point during the recovery of execution, a recovery identifier may be added at the concurrency start identifier.

FIG. 11e shows a schematic diagram of coroutine recovery.

As shown in FIG. 11e, according to an embodiment of the present disclosure, in response to searching for the recovery identifier, the concurrent communication primitive in which the communication blockage occurs is re-executed.

As shown in FIG. 11e, firstly, a search is made for whether there is a recovery identifier. If a recovery identifier is searched at the concurrent start identifier, it means that the communication blockage occurs in at least one of the concurrent communication primitives after the concurrent start identifier FB and needs to be re-executed. In this case, the concurrent start identifier FB is directly entered from the Start, and the execution of the serial communication primitives OP1 and OP2 is skipped. Then, the execution of the concurrent communication primitives OP21, OP22 and OP23 is entered. Since the concurrent communication primitive OP22 is already in the “Confirmed” state, the execution of the concurrent communication primitive OP22 will be skipped, and only the concurrent communication primitives OP21 and OP23 in which communication blockage occurs will be executed. If the communication blockage still occurs in at least one of OP21 and OP23, it may be re-executed a plurality of times from the concurrent end identifier FE, or the execution of the concurrent communication primitive may be exited from the concurrent end identifier FE, and the execution of the entire communication primitive queue may be exited.

Alternatively, according to one embodiment of the present disclosure, exiting the execution of the concurrent communication primitive based on the state of the concurrent communication primitive includes: in response to the concurrent communication primitives all being in the Confirmed state, exiting the execution of the concurrent communication primitive, and executing the serial communication primitive after the concurrent end identifier.

As shown in FIG. 11f, if the communication blockage occurs neither in the OP21 nor in the OP23, the execution of the concurrent communication primitive may be exited from the concurrent end identifier FE, and then the serial communication primitive OP3 may be executed. The execution of the serial communication primitives OP3, OP4 and OP5 has been described in conjunction with FIG. 8 above, and will not be repeated here. The execution of concurrent communication primitives has been described above in conjunction with FIGS. 11a to 11f. These concurrent communication primitives may be separate or combined with serial communication primitives as shown in FIGS. 11a to 11f.

According to one embodiment of the present disclosure, an electronic device is provided. The electronic device includes one or more processors and a memory, where the memory stores computer executable instructions, and when the computer executable instructions are executed by the one or more processors, the electronic device executes the method as described above.

According to one embodiment of the present disclosure, a computer-readable storage medium is provided. The computer-readable storage medium includes computer executable instructions, and when the computer executable instructions are executed by one or more processors, the method described above is executed.

Table 1 below shows the difference between the technical solution of the present disclosure and the first and second solutions described above.

TABLE 1

| | | | The solution of the |
|---|---|---|---|
| | A first solution: | A second solution: | present disclosure |
| Communication | Polling | Interrupt | Polling |
| synchronization | | | |
| method | | | |
| Programmability | High | Low | High |
| Computing core | Hardware multi-thread | Hardware trigger no | Software multi- |
| reuse method | time-division | multiplexing | thread time-division |
| | multiplexing | | multiplexing |
| Context switching | Preemptive | Interrupt | Non-preemptive |
| timing | | | |
| Required | Dedicated register | Dedicated hardware | No dedicated |
| hardware | group for saving | for hardware | hardware resources |
| resources | context switching | descriptor parsing | required |
| Programming | SIMT | SIMD | SIMD |
| style | | | |

The technical solution provided by the present disclosure utilizes software coroutine method to achieve the time-division multiplexing capability of the computing core without introducing hardware multithreading mechanism, thereby fully utilizing the computing core and avoiding task deadlocks. The coroutine execution process requires little hardware modification and generally supports various SIMD processing architectures to implement software time-division multiplexing. In addition, through the asynchronous confirmation method of which the primitive jump mechanism supports asynchronous communication primitives, the automatic software communication retransmission may be realized without modifying the OP (communication primitive) logic. Through the alternating execution mechanism, the concurrent execution of the plurality of communication primitives may be supported, which is similar to the effect of single-core multi-threading and saves the use of computing cores. The solution of the present disclosure is sufficient to solve the deadlock problem caused by a communication blockage.

According to different application scenarios, the electronic device or apparatus of the present disclosure may include a server, a cloud server, a server computing cluster, a data processing device, a robot, a computer, a printer, a scanner, a tablet computer, a smart terminal, a PC device, an Internet of Things terminal, a mobile terminal, a cell phone, a tachograph, a navigator, a sensor, camera, video camera, camcorder, a projector, a watch, headphones, a mobile storage, a wearable device, a visual terminal, an automatic driving terminal, a vehicle, a household appliance, and/or a medical device. The transportation tools include an aircraft, a ship and/or a vehicle; the household appliance includes a television, an air conditioner, a microwave oven, a refrigerator, an electric cooker, a humidifier, a washing machine, an electric lamp, a gas stove and a cooking machine; the medical device includes a nuclear magnetic resonance meter, a B-Supervisometer and/or an electrocardiograma electronic devices or apparatuses of the present disclosure may also be applied to the fields of the Internet, Internet of Things, data centers, energy sources, traffic, public management, manufacturing, education, grids, telecommunications, finance, retail, worksites, healthcare, and the like. Further, the electronic device or apparatus of the present disclosure may also be applied to application scenarios related to artificial intelligence, big data, and/or cloud computing such as a cloud, an edge, a terminal and so on. In one or more embodiments, the electronic device or apparatus with high computing power according to the solutions of the present disclosure may be applied to a cloud device (for example, a cloud server), and the electronic device or apparatus with low power consumption may be applied to a terminal device and/or an edge device (for example, a smart phone or a camera). In one or more embodiments, hardware information about a cloud device and hardware information about a terminal device and/or an edge device are compatible with each other, so that appropriate hardware resources can be matched from hardware resources of the cloud device according to the hardware information about the terminal device and/or the edge device to simulate hardware resources of the terminal device and/or the edge device, to achieve unified management, scheduling, and collaborative work of end cloud integration or cloud edge end integration.

The following articles may better understand the technical solution of the present disclosure.

Article 1. A method for executing an inter-chip communication task, where the inter-chip communication task is described by a communication primitive queue, the communication primitive queue includes a plurality of communication primitives, and the plurality of communication primitives include serial communication primitives connected in series, and the method includes:
executing a search for the communication primitive queue to determine states of the serial communication primitives in the communication primitive queue; and
re-executing the communication primitive queue starting from an interrupted serial communication primitive in response to searching for the interrupted serial communication primitive.

Article 2. The method of article 1, further including:
defining a state machine, where the state machine is used to describe a work state of a communication primitive;
determining whether the communication primitive is interrupted according to the work state of the communication primitive described by the state machine;
wherein the work state includes:
a pending state, used to indicate that the communication primitive has not been executed;
a working state, after the pending state, used to indicate that the communication primitive is being executed, where a communication request of the communication primitive has not been completely issued, and a response signal has not been completely received;
an executed state, after the working state, used to indicate that the communication primitive has been executed, where the communication request of the communication primitive has been completely issued, and the response signal has not been completely received; and
a confirmation state, after the executed state, used to indicate that the communication request of the communication primitive has been completely issued and the response signal has been completely received.

Article 3. The method of article 2, further comprising:
initiating execution of the communication primitive queue such that the serial communication primitives enter the working state one by one from the pending state; and
switching the work state based on execution situation of the serial communication primitives, where the switching of the work state is unidirectional.

Article 4. The method of article 3, where, for a single computing core, at most one serial communication primitive is in the working state.

Article 5. The method of article 3, where, in the communication primitive queue, the work state of the subsequent serial communication primitive is prohibited from being after the work state of the previous serial communication primitive.

Article 6. The method of any one of articles 1-5, further including: in response to a communication blockage occurring in a serial communication primitive, exiting the execution of the communication primitive queue at the serial communication primitive where the communication blockage occurs.

Article 7. The method of any one of articles 1-6, further including: in response to a communication blockage occurring in a serial communication primitive, maintaining the work state of the corresponding serial communication primitive in the executed state.

Article 8. The method of any one of articles 1-7, where re-executing the communication primitive queue starting from the interrupted serial communication primitive includes: for the serial communication primitive partially executed, only re-executing the part of the serial communication primitive that has not been executed.

Article 9. The method of any one of articles 1 to 8, wherein the plurality of communication primitives further include concurrent communication primitives that are executed concurrently, and the method further includes: executing the concurrent communication primitives in a time-division manner.

Article 10. The method of article 9, further including:
inserting a concurrent start identifier between the concurrent communication primitive and the previous serial communication primitive, so that when the communication primitive queue executes to the concurrent start identifier, the concurrent communication primitive is executed in a time-division manner; and
inserting a concurrent end identifier between the concurrent communication primitive and the next serial communication primitive, so that when the communication primitive queue executes to the concurrent end identifier, the concurrent communication primitive is re-executed according to the state of the concurrent communication primitive, or the execution of the concurrent communication primitive is exited.

Article 11. The method of article 10, where the time-division execution of the concurrent communication primitive includes: making the concurrent communication primitive to alternately enter the working state from the pending state.

Article 12. The method of article 10 or 11, where, according to the state of the concurrent communication primitive, exiting the execution of the concurrent communication primitive includes:
in response to a communication blockage not occurring in all of the plurality of concurrent communication primitives, re-executing the concurrent communication primitive.

Article 13. The method of article 12, where re-executing the concurrent communication primitive includes: for the concurrent communication primitive partially executed, only re-executing the part of the concurrent communication primitive that has not been executed.

Article 14. The method of article 12, where, according to the state of the concurrent communication primitive, re-executing the concurrent communication primitive further includes: skipping the concurrent communication primitive in the confirmed state without re-executing.

Article 15. The method of any one of articles 10-14, where according to the state of the concurrent communication primitive, exiting the execution of the concurrent communication primitive includes:
in response to a communication blockage occurring in all of the plurality of concurrent communication primitives, exiting the execution of the concurrent communication primitive and exiting the execution of the communication primitive queue.

Article 16. The method of any one of articles 10-15, where according to the state of the concurrent communication primitive, exiting the execution of the concurrent communication primitive includes:
in response to the number of times the concurrent communication primitive is re-executed reaching a predetermined number and a communication blockage occurring in at least one of the plurality of concurrent communication primitives, exiting the execution of the concurrent communication primitive and exiting the execution of the communication primitive queue.

Article 17. The method of article 15 or 16, where in response to exiting the execution of the concurrent communication primitive, adding a recovery identifier at the concurrent start identifier.

Article 18. The method of article 17, further including: in response to searching for the recovery identifier, re-executing the concurrent communication primitive in which the communication blockage occurs.

Article 19. The method of any one of articles 10-18, where according to the state of the concurrent communication primitive, exiting the execution of the concurrent communication primitive includes:
in response to the concurrent communication primitives all being in the confirmed state, exiting the execution of the concurrent communication primitive, and executing the serial communication primitive after the concurrent end identifier.

Article 20. An electronic device, including:
one or more processors; and
a memory, where the memory stores computer executable instructions, and when the computer executable instructions are executed by the one or more processors, the electronic device executes the method described in any one of articles 1-19.

21. A computer-readable storage medium, including computer executable instructions, where when the computer executable instructions are executed by one or more processors, the method described in any one of articles 1-19 is executed.

The embodiments of the present disclosure have been described in detail above. Specific examples are used in the specification to illustrate the principles and embodiments of the present disclosure. The descriptions of the above embodiments are only used to facilitate understanding of the methods and core ideas of the present disclosure. At the same time, changes or modifications made by those skilled in the art based on the ideas of this disclosure, the specific embodiments and application scope of this disclosure, all fall within the scope of protection of this disclosure. In summary, the content of this specification should not be construed as a limitation on the present disclosure.

1. A method for executing an inter-chip communication task, wherein the inter-chip communication task is described by a communication primitive queue, the communication primitive queue comprises a plurality of communication primitives, and the plurality of communication primitives comprise serial communication primitives connected in series, and the method comprises:
executing a search for the communication primitive queue to determine states of the serial communication primitives in the communication primitive queue; and
re-executing the communication primitive queue starting from an interrupted serial communication primitive in response to searching for the interrupted serial communication primitive.

2. The method of claim 1, further comprising:
defining a state machine, wherein the state machine is used to describe a work state of a communication primitive;
determining whether the communication primitive is interrupted according to the work state of the communication primitive described by the state machine;
wherein the work state comprises:
a pending state, used to indicate that the communication primitive has not been executed;
a working state, after the pending state, used to indicate that the communication primitive is being executed, wherein a communication request of the communication primitive has not been completely issued, and a response signal has not been completely received;
an executed state, after the working state, used to indicate that the communication primitive has been executed, wherein the communication request of the communication primitive has been completely issued, and the response signal has not been completely received; and
a confirmed state, after the executed state, used to indicate that the communication request of the communication primitive has been completely issued and the response signal has been completely received.

3. The method of claim 2, further comprising:
initiating execution of the communication primitive queue such that the serial communication primitives enter the working state one by one from the pending state; and
switching the work state based on execution situation of the serial communication primitives, wherein the switching of the work state is unidirectional.

4. The method of claim 3, wherein for a single computing core, at most one serial communication primitive is in the working state.

5. The method of claim 3, wherein, in the communication primitive queue, the work state of the subsequent serial communication primitive is prohibited from being after the work state of the previous serial communication primitive.

6. The method of claim 1, further comprising: in response to a communication blockage occurring in a serial communication primitive, exiting the execution of the communication primitive queue at the serial communication primitive where the communication blockage occurs, and/or maintaining the work state of the corresponding serial communication primitive in the executed state.

7. (canceled)

8. The method of claim 1, wherein re-executing the communication primitive queue starting from the interrupted serial communication primitive comprises:
for the serial communication primitive partially executed, only re-executing the part of the serial communication primitive that has not been executed.

9. The method of claim 1, wherein the plurality of communication primitives further comprise concurrent communication primitives that are executed concurrently, and the method further comprises: executing the concurrent communication primitives in a time-division manner.

10. The method of claim 9, further comprising:
inserting a concurrent start identifier between the concurrent communication primitive and the previous serial communication primitive, so that when the communication primitive queue executes to the concurrent start identifier, the concurrent communication primitive is executed in a time-division manner; and
inserting a concurrent end identifier between the concurrent communication primitive and the next serial communication primitive, so that when the communication primitive queue executes to the concurrent end identifier, the concurrent communication primitive is re-executed according to the state of the concurrent communication primitive, or the execution of the concurrent communication primitive is exited.

11. The method of claim 10, wherein the time-division execution of the concurrent communication primitive comprises: making the concurrent communication primitive to alternately enter the working state from the pending state.

12. The method of claim 10, wherein re-executing the concurrent communication primitive according to the state of the concurrent communication primitive comprises:
in response to a communication blockage not occurring in all of the plurality of concurrent communication primitives, re-executing the concurrent communication primitive.

13. The method of claim 12, wherein re-executing the concurrent communication primitive comprises: for the concurrent communication primitive partially executed, only re-executing the part of the concurrent communication primitive that has not been executed.

14. The method of claim 12, wherein, according to the state of the concurrent communication primitive, re-executing the concurrent communication primitive further comprises: skipping the concurrent communication primitive in the confirmed state without re-executing.

15. The method of claim 10, wherein, according to the state of the concurrent communication primitive, exiting the execution of the concurrent communication primitive comprises:
in response to a communication blockage occurring in all of the plurality of concurrent communication primitives, exiting the execution of the concurrent communication primitive, and exiting the execution of the communication primitive queue.

16. The method of claim 10, wherein, according to the state of the concurrent communication primitive, exiting the execution of the concurrent communication primitive comprises:
in response to the number of times the concurrent communication primitive is re-executed reaching a predetermined number and a communication blockage occurring in at least one of the plurality of concurrent communication primitives, exiting the execution of the concurrent communication primitive, and exiting the execution of the communication primitive queue.

17. The method of claim 15, wherein, in response to exiting the execution of the concurrent communication primitive, adding a recovery identifier at the concurrent start identifier.

18. The method of claim 17, further comprising: in response to searching for the recovery identifier, re-executing the concurrent communication primitive in which the communication blockage occurs.

19. The method of claim 10, wherein; according to the state of the concurrent communication primitive, exiting the execution of the concurrent communication primitive comprises:
in response to the concurrent communication primitives all being in the confirmed state, exiting the execution of the concurrent communication primitive, and executing the serial communication primitive after the concurrent end identifier.

20. An electronic device, comprising:
one or more processors; and
a memory, wherein the memory stores computer executable instructions, and when the computer executable instructions are executed by the one or more processors, the electronic device executes the method described in claim 1.

21. A computer-readable storage medium, comprising computer executable instructions, wherein when the computer executable instructions are executed by one or more processors, the method described in claim 1 is executed.
